(19) United States
(12) Patent Application Publication
(10) Pub. No.: US 2010/0302007 A1
(43) Pub. Date: Dec. 2, 2010

(54) METHODS AND APPARATUS FOR RFID READER CABLE CALIBRATION

(75) Inventors: Ron Boschini, Germantown, MD (US); Amit Asthana, Germantown, MD (US); Albert Owens, Frederick, MD (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/474,446

(22) Filed: May 29, 2009

(51) Int. Cl. H04Q 5/22

(52) U.S. Cl. 340/10.1

(57) ABSTRACT

A method for calibrating an RFID reader having a transmit port and a receive port includes connecting a cable between the transmit port and the receive port, transmitting a known signal from the transmit port to the receive port through the cable, and computing a cable loss associated with the cable based on the difference between the known signal and the signal detected at the receive port. The power level of the transmit port may then be adjusted in accordance with the cable loss and a known antenna gain.

### TECHNICAL FIELD

The present invention generally relates to radio-frequency identification systems (RFID), and more particularly relates to calibration methods used in connection with such systems.

### BACKGROUND

RFID readers, which function to both radiate and receive radio energy, often connect to one or more external antennas via a cable. Generally, the transmit power of such devices are limited by local regulatory bodies. For example, in the U.S., the FCC mandates that UHF readers radiate no more than 4W EIRP (Effective Isotropic Radiated Power) from the transmitting antenna. Since RFID system performance is directly related to transmit power level, users often find it desirable to transmit at the highest possible power level without exceeding the regulatory limit.

In order to transmit at a particular power level, it is necessary to know, with reasonable accuracy, both the gain of the antenna and the loss inherent in the antenna cable. While the gain of the antenna might be known (e.g., from the published specifications), the cable loss is generally unknown.

Many UHF readers allow the user to increase the transmit power from some default value to a higher level to account for cable loss. However, as the cable loss is usually a guess or an estimate, the result is usually non-optimal. And while it is possible to measure the cable loss using additional equipment, such a process is time-consuming and leads to additional equipment costs.

Accordingly, there is a need for improved methods for optimizing the transmission power of RFID readers and compensate for cable loss. Other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual block diagram of an RFID reader in accordance with one embodiment;

FIG. 2 depicts the RFID reader of FIG. 1 in calibration mode; and

FIG. 3 is a flowchart showing an exemplary method in accordance with the present invention.

### DETAILED DESCRIPTION

The following discussion generally relates to improved methods and apparatus for compensating for cable loss in RFID readers. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to RF devices, RFID tags, RFID readers, and the like need not and will not be described herein.

In general, the present invention relates to a method for calibrating an RFID reader by coupling a cable between a transmit (Tx) port and a receive (Rx) port, then sending a signal having known characteristics through Tx port to the Rx port to compute the cable loss. The transmit power of the Tx port can then be adjusted to compensate for the cable loss and achieve a desired level for a given antenna gain.

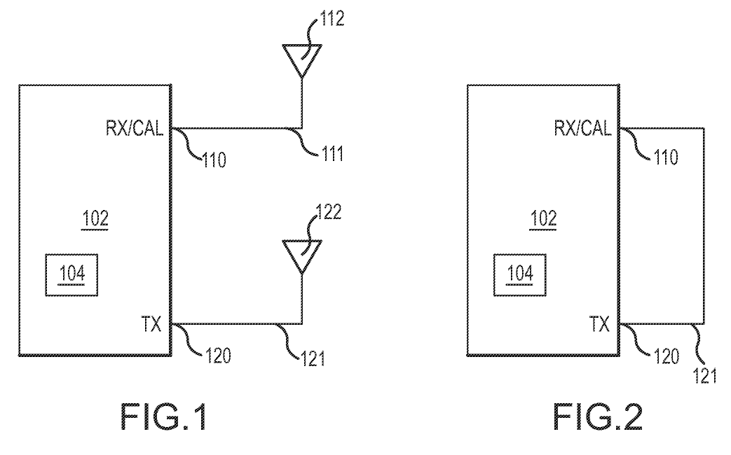

Referring to FIG. 1, an RFID system generally includes an RFID reader (or simply “reader”) 102 having one or more Rx ports 110, and one or more Tx ports 120. A particular Rx port 110 may be designated as a special “calibration” port. For the purposes of simplicity, the illustrated embodiment includes only two such ports, but it will be appreciated that the present invention is not so limited. Furthermore, while the present invention may be discussed in the context of UHF RFID readers, the methods described herein may be used in conjunction with any type of RFID reader.

Rx port 110 is configured to removeably connect to a cable 111, e.g., any of the various RF cables known in the art. Cable 111, during a normal operation mode, will typically be coupled to an external antenna 112. Similarly, Tx port 120 is configured to removeably connect to a cable 121 which, during the normal operation mode, is attached to another external antenna 122.

Reader 102 includes a processor 104, which will typically include a memory, I/O, etc., and will be configured to execute machine readable instructions (e.g., stored in the memory) to accomplish the various steps described herein. Reader 102 may also include a number of additional semiconductor devices, RF devices, DSPs, analog components, and other electrical components. As the operation of conventional RF readers are well known in the art, for the sake of clarity such components are not illustrated in the figures.

Processor 104 is configured to operate reader 102 in two modes: a normal operation mode, and a calibration mode. In the normal operation mode, reader 102 transmits a suitable signal through transmit port 120, cable 121, and antenna 122. The signal is capable of activating passive RFID tags (e.g., UHF tags) within its range, thus prompting those tags to transmit data associated therewith. At the same time, reader 102 is configured to receive the transmitted data from the RFID tags within range (not illustrated) via antenna 112, cable 111, and receive port 110. Processor 104 then typically processes and forwards that data to an external computer or device over a network, either wirelessly or otherwise.

As previously mentioned, it is desirable that the output power at antenna 122 be as high as possible without exceeding the applicable regulatory limits (e.g., 4W EIRP in the U.S.). While the gain of antenna 122 may be known with reasonable accuracy, the loss due to cable 121 will generally be unknown.

Thus, in accordance with one aspect of the present invention, during calibration mode, which may be selected by an operator using any suitable user interface, processor 104 instructs reader 102 to enter a mode in which the cable loss of cable 121 is determined.

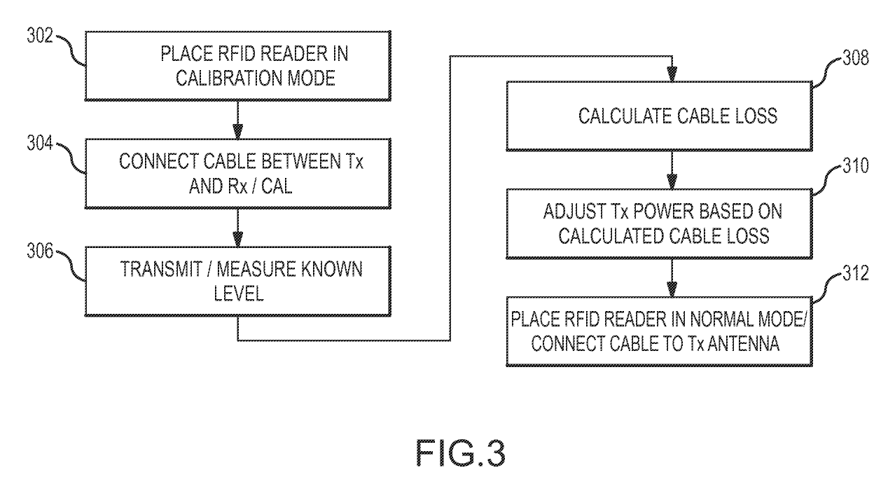

More particularly, referring now to the flowchart of FIG. 3 in connection with the block diagram of FIG. 2, once the calibration mode is selected (step 302), cable 121 is connected (manually or automatically) between Rx port 110 and Tx port 120 (step 304).

Next, a signal with known characteristics—including power level—is transmitted from Tx port 120 to Rx port 110 (step 306). The characteristics of the signal received at the Rx port 110 will be a modified signal whose characteristics will vary depending upon the nature of cable 121.

Processor 104 (in conjunction with other relevant components) can then determine the cable loss based on the known transmitted signal and the received modified signal (step 308). For example, it might be determined that the signal has been attenuated by 1.0 db. The determination of signal attenuation is well known in the art, and need not be described herein.

Next, the transmit power of Tx port 120 is adjusted to compensate for the calculated cable loss (step 310). Reader 102 is then placed in normal operation mode (step 312) and its cables 111, 121 and associated antennas 112, 122 are reconfigured as shown in FIG. 1.

In this way, the transmit power of Tx port 120 may be adjusted to achieve an effective output power (e.g., EIRP power) based on the cable loss of cable 121 and the gain of antenna 122 (assuming that the latter is known). For example, assume that antenna 122 has a known gain of 6 dBiL, and the target output power is 4W EIRP. Further assume that the calibration mode was used to determine that cable 121 has a cable loss of 1 dB. Processor 104 can then adjust the transmit power of port 120 to 31 dBm out of the port. That is, the link budget calculation becomes 31 dBm−1 dB+6 dB=36 dB=4W EIRP.

As many RFID readers operate in a monostatic mode (i.e., where each port can both transmit and receive), in an alternate embodiment one monostatic port serves as a Tx port and another monostatic port acts an as Rx port when in the calibration mode.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A method for calibrating an RFID reader having a transmit port and a receive port, the transmit port having an adjustable power level, the method comprising:
connecting a cable between the transmit port and the receive port;
transmitting a known signal from the transmit port;
receiving a modified signal, based on the known signal, from the receive port;
computing a cable loss associated with the cable based on the known signal and the modified signal;
adjusting the power level of the transmit port in accordance with the cable loss.

2. The method of claim 1, further including disconnecting the cable from the receive port, and connecting the cable to an antenna having an antenna gain.

3. The method of claim 2, further including adjusting the power level of the transmit port in accordance with the cable loss and the antenna gain.

4. The method of claim 3, further including increasing the power level of the transmit port to compensate for the cable loss such that the antenna transmits at a level substantially equal to a predetermined maximum power level.

5. The method of claim 4, further including transmitting within a UHF band.

6. A RFID reader comprising:
a transmit port configured to removeably couple to a cable;
a receive port configured to removeably couple to the cable;
a transmit antenna configured to removeably couple to the cable;
a processor configured to operate the RFID reader in a normal mode and a calibration mode;
wherein, while in the calibration mode, and the cable is coupled between the transmit port and the receive port, the processor is configured to: transmit a known signal from the transmit port, receive a modified signal from the receive port, and computing a cable loss associated with the cable based on the known signal and the modified signal;

7. The RFID reader of claim 6, wherein the processor is further configured to adjust the power level of the transmit port in accordance with the cable loss.

8. The RFID reader of claim 7, wherein the processor is configured to adjust the power level in accordance with a predetermined antenna gain.

9. The RFID reader of claim 8, wherein the processor is configured to the power level of the transmit port to compensate for the cable loss such that the antenna transmits at a level substantially equal to a predetermined maximum power level.

10. The RFID reader of claim 6, further including one or more additional transmit ports, and one or more additional receive ports.

11. The RFID reader of claim 6, wherein the receive port is a designated calibration port.

12. The RFID reader of claim 6, wherein the processor is configured to transmit a UHF signal through the transmit port.

13. The RFID reader of claim 12, wherein the RFID reader is configured to read and write UHF passive tags.

14. A method of calibrating an RFID reader, comprising:
connecting a cable between a first port and a second port associated with the RFID reader;
transmitting a signal having a first power level from the first port to the second port through the cable;
receiving a signal having a second power level at the second port during the transmitting step;
computing a cable loss for the cable based on the difference between the first power level and the second power level; and
adjusting a transmit level of the first port in accordance with the cable loss and a predetermined antenna gain to achieve an effective isotropic radiated power that is substantially equal to a target power level.

15. The method of claim 14, wherein the target power level is associated with a signal in the UHF band.

16. The method of claim 14, wherein the first port is a monostatic port set to a transmit mode during calibration.

17. The method of claim 16, wherein the second port is a monostatic port set to a receive mode during calibration.
